(19) United States
(12) Patent Application Publication
(10) Pub. No.: US 2018/0053151 A1
(43) Pub. Date: Feb. 22, 2018

(54) MODULAR TRANSPORTATION SYSTEM WHICH CAN BE INTEGRATED INTO A MOTOR VEHICLE

(71) Applicant: Ford Global Technologies, LLC, Dearborn, MI (US)

(72) Inventors: Marcel Mathissen, Wurselen (DE); Thomas Baranowski, Wurselen (DE)

(73) Assignee: Ford Global Technologies, LLC

(21) Appl. No.: 15/674,664

(22) Filed: Aug. 11, 2017

(30) Foreign Application Priority Data
Aug. 17, 2016 (DE) 102016215402.8

(51) Int. Cl. G06Q 10/08; B60R 7/02; B60R 5/04; B60N 3/10

(52) U.S. Cl. CPC G06Q 10/0836; B60R 7/02; B60R 5/04; B60P 3/007; B60N 3/104; B60N 3/105; B60N 3/103

(57) ABSTRACT

A modular system for transporting objects in a motor vehicle, particularly for purchasing and transporting purchased goods, is disclosed. The system has at least one module which is suitable for receiving objects, can be removed from the system and can be replaced with another module, and can be connected to the system and therefore to the motor vehicle by a plug-and-play connection. Furthermore, a method for purchasing and transporting goods is made available.

### FIELD OF THE INVENTION

The present invention generally relates to a modular system for transporting objects in a motor vehicle, and more particularly to a modular system for purchasing and transporting purchased goods.

### BACKGROUND OF THE INVENTION

Consumer goods, particularly foodstuffs, are usually purchased by the person looking for a corresponding shop and carrying the purchased goods home or transporting them with a motor vehicle. However, many users of a motor vehicle often find the time expended on shopping, e.g., weekly food shopping, to be too high. In order to avoid this expenditure, many shops offer a delivery service for ordered goods. However, these delivery services often entail additional costs and can frequently only be implemented in relatively large towns. In addition, deliveries frequently take a relatively long time. As an alternative to deliveries, shops also offer pick up services in which goods which have been ordered are made available for picking up at an agreed time.

It would be desirable to make available an improved suitable transportation opportunity for objects, particularly goods, can be transported on a motor vehicle.

### SUMMARY OF THE INVENTION

According to one aspect of the present invention, a modular system for transporting objects in a vehicle is provided. The system includes at least one module for transporting objects and reversibly removable from the system and replaceable with another module with same dimensions, wherein conditions within the module can be regulated, the module can be connected to the system via a plug-and-play connection, and wherein the system can be connected to a control device of the vehicle via a plug-and-play connection.

According to another aspect of the present invention, a modular system for transporting objects in a vehicle is provided. The system includes a module for transporting objects that is reversibly removable from the system and replaceable with another module with same dimensions, and a device for regulating one or more conditions within the module. The system also includes a first plug-and-play connection connecting the module to the system, and a second plug-and-play connection connecting the system to a control device of the motor vehicle.

According to yet a further aspect of the present invention, a method for transporting objects is provided. The method includes the following steps of making available a modular system in a vehicle, producing a preliminary list of objects to be transported, and detecting available space in at least one module of the system. The method also includes the steps of comparing the preliminary list with the available space and providing a definitive list, transmitting the definitive list to a destination where the objects are available, and receiving in the system the objects which are available.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a rear schematic illustration of an embodiment of a modular system for transporting objects in a motor vehicle;

FIG. 2 is a flow chart illustrating an embodiment of a method for transporting objects in a modular system in a motor vehicle; and

FIG. 3 is a block diagram further illustrating one embodiment of the modular system shown in FIG. 1.

### DETAILED DESCRIPTION OF THE PREFERRED EMBODIMENTS

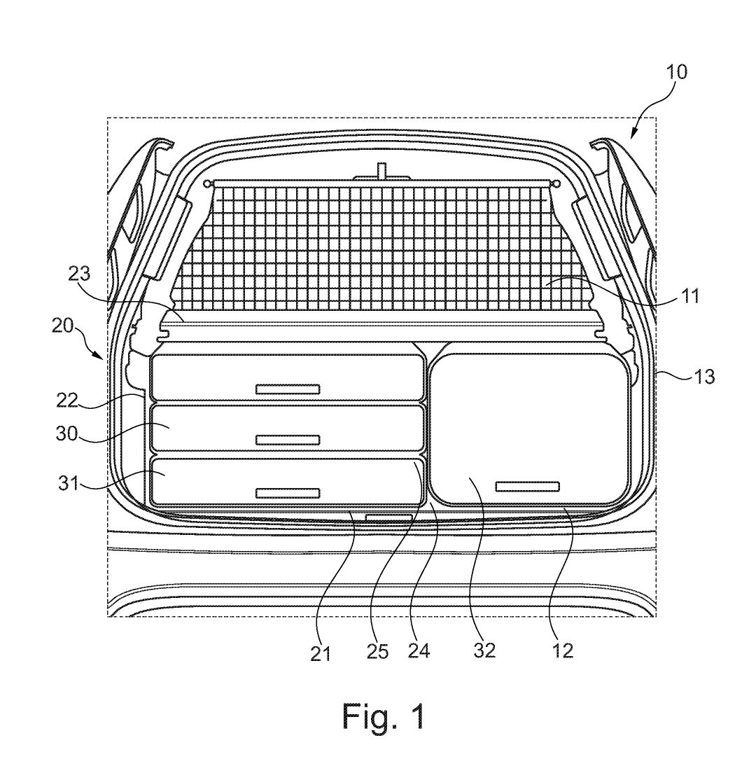

FIG. 1 illustrates in a schematic form the rear side of a motor vehicle 10 in which a modular system 20 according to one embodiment is arranged. The system 20 is fitted in a load compartment 11 of the motor vehicle shown as an estate car or an SUV which is formed by a load area 12 and the vehicle walls 13. Alternatively, the system 20 can, for example, also be arranged in the trunk of a motor vehicle in the form of a limousine or in the load compartment of a van.

In FIG. 1, the system 20 shown in this embodiment is embodied as a right parallelepiped in its external shape. The external shape of the system 20 can alternatively be adapted to the shape of the vehicle, that is to say, e.g., to vehicle walls 13 which run obliquely upward at the sides. The system 20 can also fill an entire load compartment, in which case the system 20 has, e.g., perpendicular walls in the lower area, and in the upper area, as oblique walls adapted to the shape of the vehicle.

The system 20 is bounded by a lower wall 21, two side walls 22, a rear wall (not shown) which is directed toward the driver's side and an upper wall 23. The system 20 can also have a front wall which is directed toward the rear side of the vehicle 10, or a door-like opening; however, it is preferably open, as illustrated in FIG. 1. Furthermore, the system 20 has an intermediate wall 24 which, like the side walls 22 has recesses 25 which are provided for arranging the modules 30. A plurality of intermediate walls for arranging the modules can also be present depending on the number and the shape of the modules 30. The walls are comprised of a material which ensures the stability of the system 20, e.g., of a polymer or of a mixture of polymer compounds or, e.g., a metal or a metal alloy.

The system 20 has four modules 30 in the illustrated embodiment. Three modules with a first module shape 31 which are arranged one on top of the other and extend over half the width of the vehicle are illustrated on the left. On the right, a single module with a second module shape 32 is illustrated, which module corresponds in height to the three module shapes 31. The modules 30 can also be shaped and arranged differently. It is clear that the modules 30 can have a different shape and be present in a different number than illustrated.

The modules 30 are ideally manufactured from the same material as the walls of the system 20. However, they can also be composed of another material. The modules can have a right-parallelepiped shape. The modules 30 are ideally embodied in the form of a drawer, with a lower wall and four side walls, wherein a handle for pulling out the module is arranged on the wall facing the rear side of the vehicle 1. The modules 30 can also be divided into a plurality of subunits, e.g., by structures or else have individual containers.

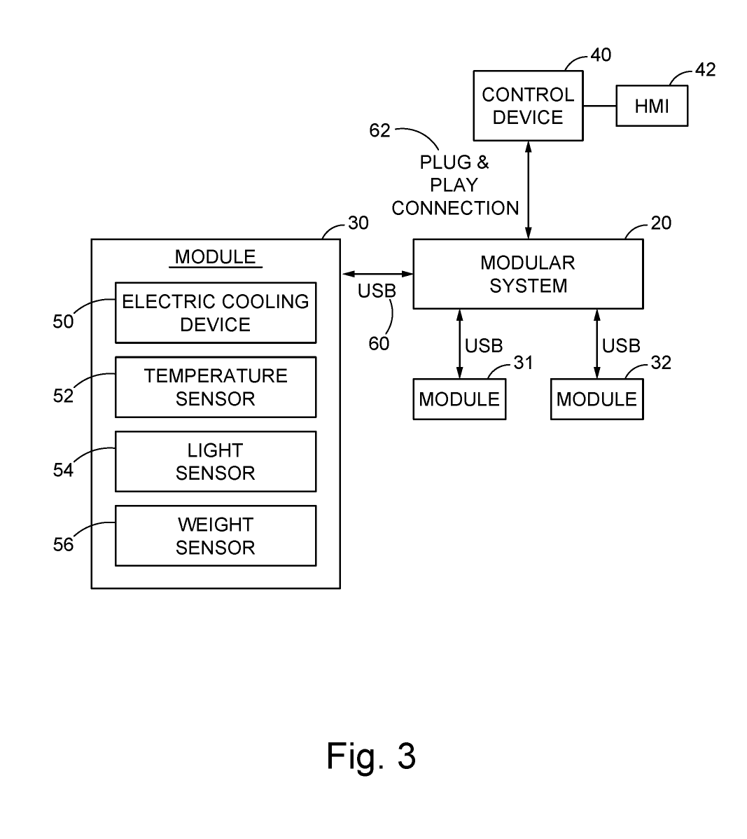

Both the walls of the system 20 and the walls of the modules 30 can have insulation for maintaining the temperature, which insulation may be embodied in a way known to a person skilled in the art. The system 20 preferably has active cooling, particularly the modules 30 as shown in FIG. 3 have active cooling, and preferably individual modules 30 have active cooling independently of one another. For this purpose, the cooling may be made available in a way known to a person skilled in the art, e.g., by means of an electric cooling device 50. The electric energy for operating the cooling device 50 can be made available by a battery of the motor vehicle 10 or by a system-integrated battery. In order to check the cooling function, at least the modules 30 with a cooling function have at least a temperature sensor 52.

Referring again to FIG. 3, the modular system 20 can be connected to a control device 40 of the motor vehicle, e.g., an on-board computer, via a plug-and-play connection 62. Furthermore, each individual module 30 can also be connected to the system 20 via a plug-and-play connection 60 and therefore also indirectly to the control device 40 of the motor vehicle. The connection can be produced with a USB plug connection, for example. In this way, the system 20 and the individual modules 30 can be controlled directly by means of the operator control means using human machine interface (HMI) 42 of the control device 40.

The cooling of the individual modules 30 can be set and controlled, for example, by means of the operator control means of the control device of the motor vehicle 10. However, it is also possible for the cooling of the individual modules 30 to be actuated immediately when the plug-and-play connection between the modules 30 and the system 20 or the motor vehicle 10 is established.

The individual modules 30 have at least one device by means of which the status of the respective module 30 can be checked, e.g., a light sensor 54 and/or a weight sensor 56. The status is detected by the control device of the motor vehicle 10 and transmitted, for example, to the driver or to another user of the motor vehicle 10.

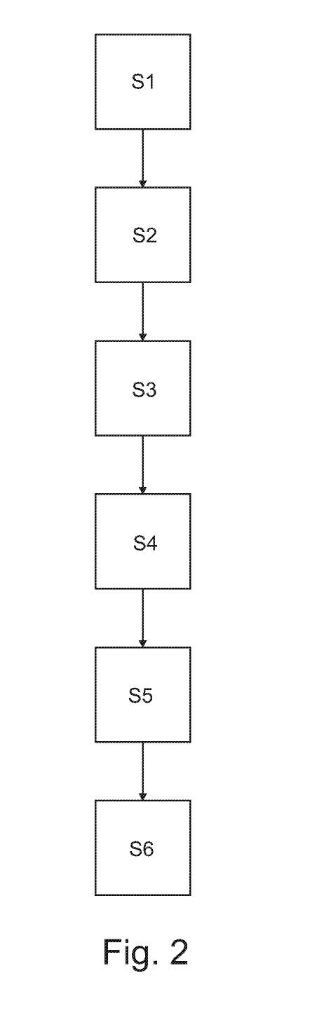

A method according to the illustration in FIG. 2 for transporting objects may particularly be a method for purchasing and transporting goods such as foodstuffs. In a first step S1, for this purpose of the method the modular system 20 is made available in a motor vehicle 10. In a second step S2, the driver or another occupant of the motor vehicle 10 produces a preliminary list with goods to be purchased. The preliminary list is input into the control device of the motor vehicle 10 using corresponding instruments of the motor vehicle 10. Alternatively, the input can take place online, that is to say by Internet, e.g., using a tablet PC or via a direct interface between an external device, e.g., a cellphone, and a motor vehicle. The control device makes contact with the system 20. The system 20 then detects in a third step S3 whether there is sufficient space available in at least one module to accommodate the goods which are to be purchased in a planned fashion. If goods are to be purchased which have to be cooled, particularly the space in coolable modules is checked and, if appropriate, the cooling of these modules is actuated.

In a fourth step S4, the preliminary list is compared with the space available in the system, wherein as a result a definitive list is produced. The definitive list contains the goods which can be accommodated in the system 20. In a fifth step S5, the definitive list is transmitted to a destination at which the goods are made available. The destination may particularly be a business in which goods, in particular foodstuffs, can be acquired, for example, a supermarket. The transmission of the definitive list can be carried out online, that is to say by Internet, e.g., using a tablet PC, an internet-enabled cellphone or via the on-board computer, or directly by phone. The transmitted list contains additional information on the type of the containers or modules, number of the free containers or modules, location of the motor vehicle, model of the motor vehicle and expected time for the objects which have been made available to be received.

The goods to be purchased are made available at a specific location, i.e., particularly a specific car park. The driver of the motor vehicle receives information as to how he reaches this location. The goods to be purchased are preferably made available in modules which correspond in size and shape to the modules 30 which are contained in the modular system 20 of the motor vehicle. In a sixth step S6, the goods which have been made available are received in the system. The modules which have been made available are replaced with empty modules 30. The modules which have been made available are connected to the system 20 and therefore to the motor vehicle 10 by means of a plug-and-play connection. The empty modules are left at the location where the goods are purchased. The goods are paid for within the scope of the acceptance.

In one embodiment, the system is designed to check the correctness of the purchased goods. This can be done, for example, by means of RFID chips (radio-frequency identification-identification using electromagnetic waves).

One aspect of the disclosure relates to a modular system for transporting objects in a motor vehicle, comprising at least one module which is suitable for transporting objects, wherein the module can be reversibly removed from the system, wherein the module can be replaced with another module with the same dimensions, wherein the conditions within the module can be regulated, the module can be connected to the system via a first plug-and-play connection, and wherein the system can be connected to a control device of the motor vehicle via a second plug-and-play connection.

The size of the available space can advantageously be detected automatically by the system by means of suitable devices. It is also advantageous that the conditions within a module can be regulated with respect to the objects to be transported. Furthermore, it is advantageous that the modules are replaceable so that prepared modules or containers can be stowed in a time-saving fashion in the system and therefore in the motor vehicle. In addition, the transported goods can be arranged in an orderly way because there are no loose bags or loose objects which can move in the motor vehicle.

Objects which are to be transported with the system may be goods which have been purchased, and quite particularly may be foodstuffs. However, other goods can also be transported in this way with the system.

The term module is used to refer to a unit of the system which is spatially separated from other parts of the system, can be controlled individually and can be removed from the system. A module can be composed of a container or else have a plurality of containers which are also referred to as subunits. There is provision hitherto that a module can be replaced with another module with the same dimensions, i.e., with the same height, width and length.

The conditions which can be regulated within the module preferably comprise the temperature. In this context, all the modules which the system comprises can be cooled, or individual modules, or else subunits within a module, can be cooled. The temperature can be ideally reduced here so that transported objects are cooled. The corresponding module has for this purpose temperature sensors and cooling devices known to a person skilled in the art.

The modular system can be connected to the on-board electronics of the motor vehicle by a plug-and-play connection. The principle of the plug-and-play system means that the connection is made available via a plug-type connection and the system can be operated without making specific settings or installing device drivers via the on-board electronics. The term on-board electronics comprises in this context a control device, e.g., an on-board computer, which can be operated by a user of the motor vehicle by means of instruments. Correspondingly, a module of the system can also be connected to the system, and therefore also indirectly to the motor vehicle or to the on-board electronics of the motor vehicle, by means of a plug-and-play connection.

In the system, a status of the module, particularly with respect to objects which have already been received and available space, can preferably be transmitted to the motor vehicle. The system is correspondingly designed to detect the status of the module, e.g., by means of weight sensors and/or light sensors within the module.

In the system, the number and the status of the available modules can preferably be detected by the system and transmitted to the motor vehicle. The system is correspondingly designed to detect the status of the available modules, e.g., by means of weight sensors and/or light sensors within the individual modules.

The size of the system can preferably be adapted to an area of the motor vehicle which is provided for transportation. The area which is provided for transportation is, e.g., a load area of a minibus, a trunk of a limousine or a trunk of an estate car or of an SUV (sport utility vehicle). In other words, the system is made available with a size which fits in the specified areas. In this context, the system can be made available in a type-appropriate fashion, i.e., for a specific model of a motor vehicle or a specific model group or a specific system.

Another aspect of the disclosure relates to a method for transporting objects, comprising the steps of making available the modular system in a motor vehicle, producing a preliminary list of objects to be transported, detecting the available space in at least one module of the system, comparing the preliminary list with the space available in the system, wherein as a result a definitive list is produced, transmitting the definitive list to a destination at which the objects are made available, and receiving in the system the objects which have been made available.

The objects are preferably made available in modules which correspond in their dimensions to the modules of the modular system. In this way, entire modules can advantageously be replaced by replacing an empty module with a module which is filled with the objects to be transported.

The lists, i.e., the preliminary and the definitive list, preferably contain additional information on the type of the containers or modules, number of the free containers or modules, location of the motor vehicle, model of the motor vehicle and expected time for the objects which have been made available to be received. In this way, the objects which are to be transported can advantageously be made available in suitable modules and received in the system in a time-saving fashion.

Goods which are purchased and transported with the vehicle are preferably received in the method as objects. In this way, food shopping can advantageously be carried out in a time-saving fashion and temperature-sensitive goods can be reliably transported to a destination with possibility of cooling individual modules.

It will be understood that any described processes or steps within described processes may be combined with other disclosed processes or steps to form structures within the scope of the present invention. The exemplary structures and processes disclosed herein are for illustrative purposes and are not to be construed as limiting.

What is claimed is:

1. A modular system for transporting objects in a vehicle, comprising:
at least one module for transporting objects and reversibly removable from the system and replaceable with another module with same dimensions, wherein conditions within the module can be regulated, the module can be connected to the system via a plug-and-play connection, and wherein the system can be connected to a control device of the vehicle via a plug-and-play connection.

2. The system as claimed in claim 1, wherein the conditions which can be regulated within the module comprise temperature.

3. The system as claimed in claim 2, wherein the conditions are regulated by a device that regulates the temperature.

4. The system as claimed in claim 1, wherein a status of the module with respect to objects which have already been received and available space can be transmitted to the vehicle.

5. The system as claimed in claim 1, wherein a number and a status of the available modules can be detected by the system and transmitted to the vehicle.

6. The system as claimed in claim 1, wherein a size of the system is adapted to an area of the motor vehicle which is provided for transportation.

7. The system as claimed in claim 1, wherein the modular system is located on a motor vehicle.

8. A modular system for transporting objects in a vehicle, comprising:
a module for transporting objects that is reversibly removable from the system and replaceable with another module with same dimensions;
a device for regulating one or more conditions within the module;
a first plug-and-play connection connecting the module to the system; and
a second plug-and-play connection connecting the system to a control device of the motor vehicle.

9. The system as claimed in claim 8, wherein the one or more conditions which can be regulated within the module comprise temperature.

10. The system as claimed in claim 9, wherein the regulator comprises a cooling device.

11. The system as claimed in claim 8, wherein a status of the module with respect to objects which have already been received and available space can be transmitted to the vehicle.

12. The system as claimed in claim 8, wherein the number and the status of the available modules can be detected by the system and transmitted to the vehicle.

13. The system as claimed in claim 8, wherein the size of the system is adapted to an area of the vehicle which is provided for transportation.

14. The system as claimed in claim 8, wherein the modular system is located on a motor vehicle.

15. A method for transporting objects, comprising the steps:
making available a modular system in a vehicle;
producing a preliminary list of objects to be transported;
detecting available space in at least one module of the system;
comparing the preliminary list with the available space and providing a definitive list;
transmitting the definitive list to a destination where the objects are available; and
receiving in the system the objects which are available.

16. The method as claimed in claim 15, wherein the objects are made available in modules which correspond in their dimensions to at least one module of the modular system.

17. The method as claimed in claim 15, wherein the lists contain additional information on the type of the modules, number of the free modules, location of the vehicle, model of the vehicle and expected time for the objects which are available to be received.

18. The method as claimed in claim 15, wherein the objects are goods which are purchased and transported with the vehicle.

19. The method as claimed in claim 15 further comprising the step of regulating temperature within the at least one module with a regulating device based on sensed temperature.

20. The method as claimed in claim 15, wherein the vehicle is a motor vehicle.
